(19) United States
(12) Patent Application Publication
(10) Pub. No.: US 2007/0033102 A1
(43) Pub. Date: Feb. 8, 2007

(54) Securely providing advertising subsidized computer usage

(75) Inventors: Alexander Frank, Bellevue, WA (US); Isaac P. Ahdout, Bellevue, WA (US); James S. Duffus, Seattle, WA (US); Thomas G. Phillips, Bellevue, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/321,668

(22) Filed: Dec. 29, 2005

Related U.S. Application Data
(63) Continuation-in-part of application No. 11/092,041, filed on Mar. 29, 2005.

(51) Int. Cl. G06Q 30/00

(52) U.S. Cl. 705/14

(57) ABSTRACT

A method and apparatus for assuring delivery of paid advertising to a user may involve asking a question about an advertisement or requiring data about the advertisement to be entered. In one embodiment, a human presence indicator, such as stylized letters, may be displayed during or after the presentation of an advertisement to be copied by a user to indicate presence during the advertisement. When the challenge relating to ad viewing is correctly answered, a value associated with viewing the ad may be credited to a user account, either locally or at a clearinghouse or other repository.

This application is a continuation-in-part of U.S. patent application Ser. No. 11/092,041, filed Mar. 29, 2005, which is incorporated by reference for all purposes.

### BACKGROUND

A service provider such as a telephone company, an Internet service provider, or a leasing company may provide computer systems or components to users at a reduced charge or for free in exchange for viewing advertising, especially targeted advertising, as is discussed in the above-cited priority document. Resources on the computer system itself, such as the operating system, may identify user characteristics and interests based on information stored on the computer. A user profile may be developed using information such as music preference, language, and game usage. User profile data may be shared with an advertising provider, either directly, or through the service provider, to allow development of targeted advertising for presentation on the computer system when the computer system is both online and off-line.

The value to an advertiser is not, however, in delivering the advertisement to the computer. The value is realized when a human viewer consumes the advertisement and the particular message of the advertisement is conveyed to a user. The consumption of an advertisement by a human user is even more important when one option for paying for the subsidized computer is through the delivery of paid advertising. Attestation of delivery may be challenging. Simply presenting the advertisement offers little or no assurance that the ad was consumed by a human. Even verifying the presence of a user, e.g. by use of a camera, may provide assurance that someone is there, but not necessarily that he or she is paying attention to the advertisement.

### SUMMARY

In order to attest consumption of advertising by a human, preferably a member of the target population, several mechanisms may be employed. After gathering data about a user, the targeted advertising containing both a challenge and a correct response may be presented to the user. During or after the presentation of the ad, the challenge, may be presented. The challenge may be a question about the content of the ad (who was driving the car?) or presentation of unrelated data (the response number is 213). The user may enter a response to the challenge. The response may be processed locally, for example, in a cryptographic unit. When the correct response is not included in the advertisement, the user's response may be signed, encrypted, or both, and sent to a server for verification. When the response is verified, value may be added to a user account. The value may be used for extending a usage period for the computer, or may be stored as points and used for subsequent purchases. When processed locally, the advertisement itself may contain a provisioning packet for use in updating the user's value account. In other embodiments, successful verification of the response, either locally or at a server, may cause a provisioning packet to be generated and sent to the user's computer or other electronic device.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a representation of targeted advertising data;

FIG. 4 is a flow chart of a method of attestation for paid consumption of advertising on a computer; and

FIG. 5 is an example of a “human is present” graphic.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

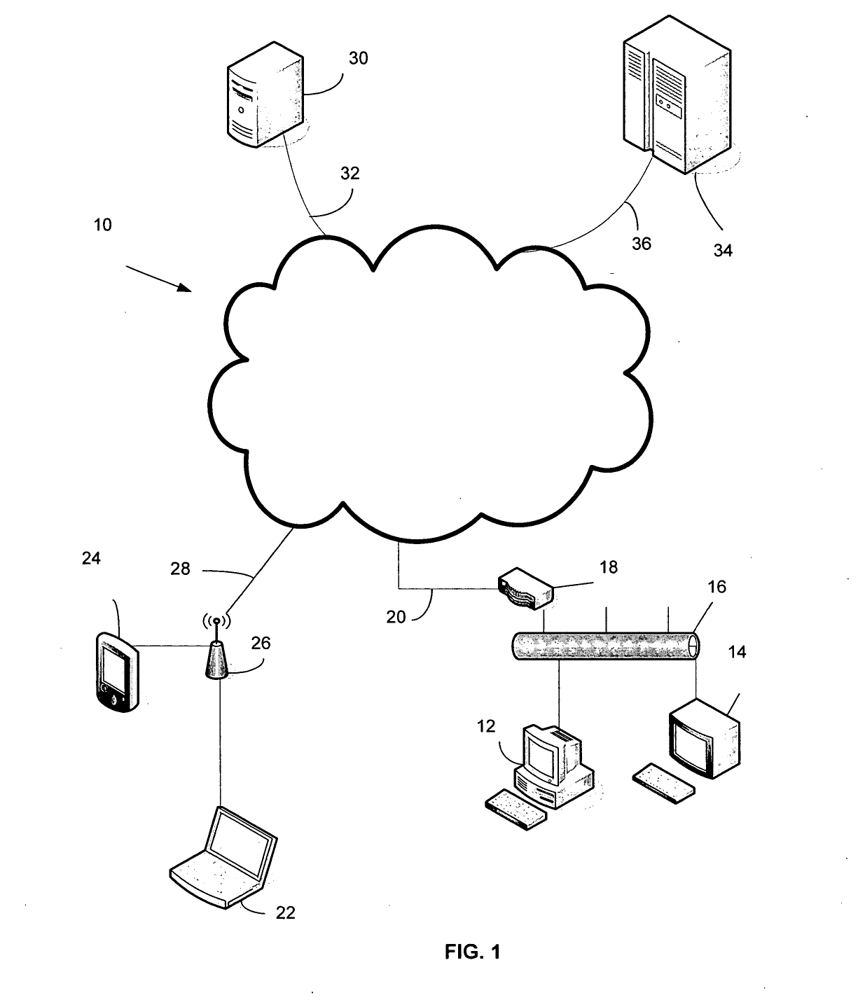

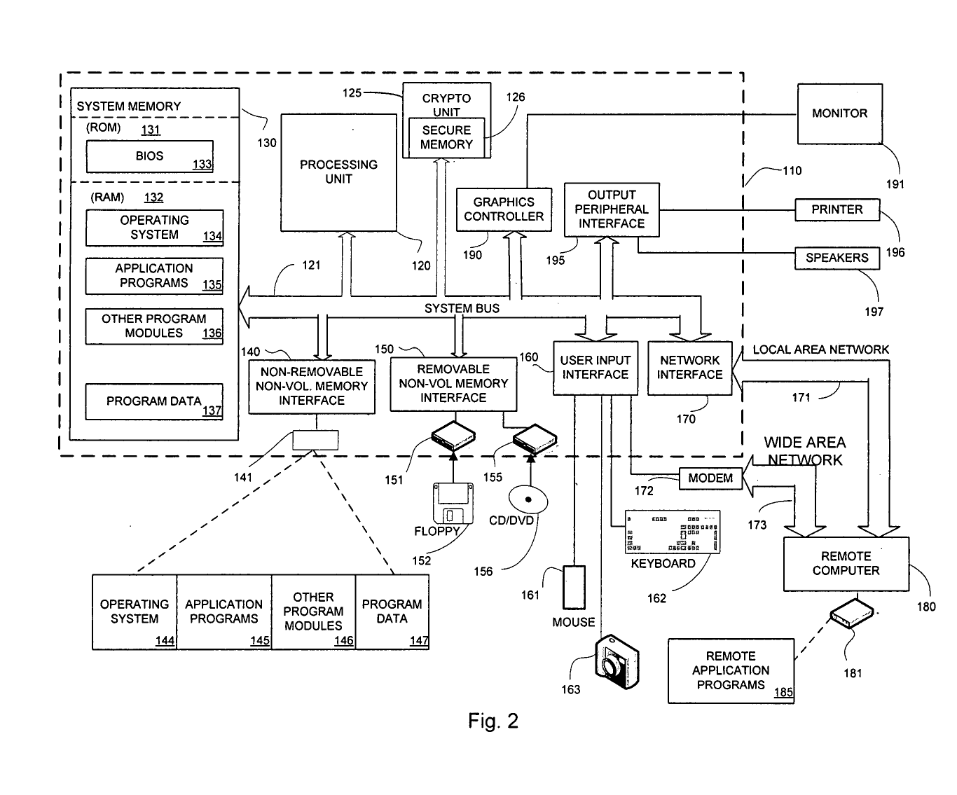

FIGS. 1 and 2 provide a structural basis for the network and computational platforms related to the instant disclosure.

FIG. 1 illustrates a network 10 that may be used to support an advertising compensation system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected, or secure memory 126 for storing keys and other secret data. In addition, the cryptographic unit 125 may include an RNG (random number generator) which is used to provide random numbers. In other embodiments, the functions of the cryptographic unit may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modern 172 or other means for establishing communications over the WAN 173, such as the Internet. The modern 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

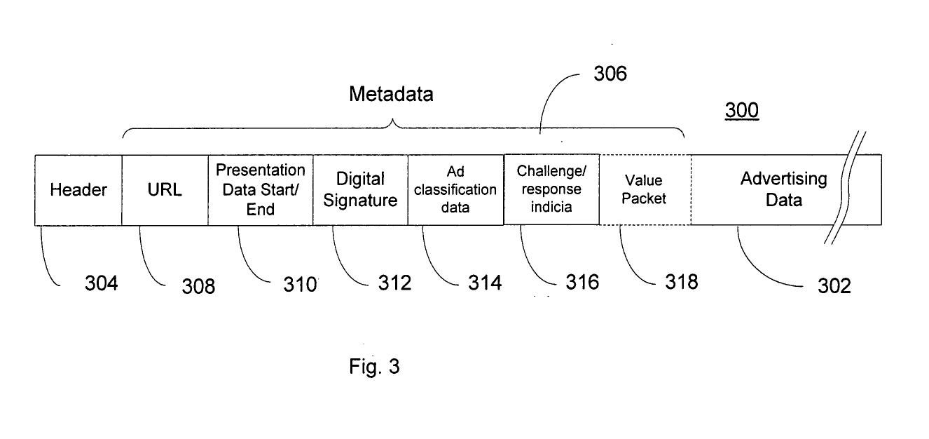

FIG. 3 illustrates representative data that may be present in a targeted advertisement. Advertising data 302 may include graphics, sound, motion video, text, etc. beyond the advertising data content 302. The targeted advertisement 300 may also include header data 304 for routing and file management, metadata 306 including advertisement classification data 314 and an optional value packet 316. The metadata 306 may include information useful in verifying and reporting presentation of the advertising content. For example, a URL 308 may specify where presentation reporting data may be sent. Presentation data start and end 310 may be used by the graphics controller 190 to determine start and end points over which a digital signature 312 may be verified. The use of the metadata 306 for verification and notification of advertising delivery is discussed in more detail in parent application Ser. No. 11/092,041. The ad classification data 314 may be used in ad targeting, particularly when ad targeting is performed locally, using local user data, but may also be part of server-based targeting.

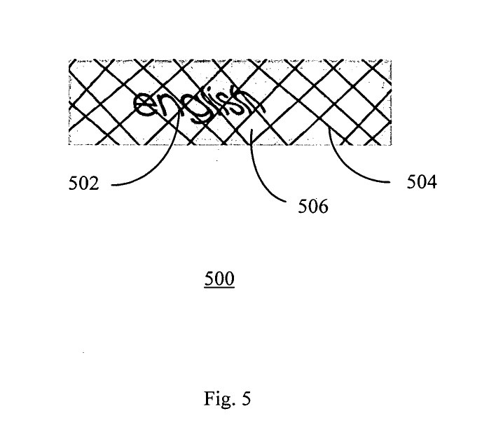

The challenge/response indicia 316 may be cryptographically protected against discovery and fraudulent use. In one embodiment, the cryptographic unit 125 has a key that may be used to decrypt data in the challenge/response indicia 316. The challenge/response indicia 316 may include a question and a required response or the required response only when the question is contained in the ad data 302. The challenge may be video, audio, text, graphics, etc. The challenge may be a question about something that appears in the advertisement. Alternately, the challenge may be a separate piece of data, such as a “human interactive proof” (HIP) data. HIP data are common in several applications, such as ticket purchase web sites for limiting automated purchase of tickets. Referring briefly to FIG. 5, one form of HIP indicia is shown. The HIP indicia 500 is designed to limit the ability of text recognition software to discern the stylized word. In this example, the word “english” 502 is shown with the letters misshapen. An offset grid, non-uniform, pattern 504 is overlaid on the word 502 and a shaded background pattern 506. By entering the word in an input box, a certain confidence can be gained that a human is present and responding. Another form of HIP can be a sound file, where the sound file plays a question to be answered. Alternately, the sound file may be played at the end of an advertisement and may contain a word to be copied into an entry field. Other HIP indicators, such as digital watermarks, are known and may be used to attest or at least improve confidence that a human is present.

The challenge or the ad itself may also include the credit amount for displaying to the user, that is, the value associated with watching the ad and providing a correct response to the challenge. In an exemplary embodiment, there may be advertisements, for example, those requiring interaction, or very low value ads, that do not require a human response to the challenge. That is, the advertisement itself, or the process delivering the advertisement, may present the correct response data on behalf of the user causing the ad value to be credited.

The optional value packet 318 may be a provisioning packet that can be released upon a successful response, thereby crediting a value store (not depicted) immediately without need to contact a host or provisioning service to deliver the compensation value to the user. The value packet may also be encrypted, wherein the process associated with validating a correct response triggers an activity that both decrypts the provisioning packet and causes the provisioning packet to be processed. In one embodiment, the keys for decrypting an encrypted value packet may be stored in the cryptographic unit. The encryption of the value packet and the key used for decryption may be unit specific, that is, tied to a particular computer.

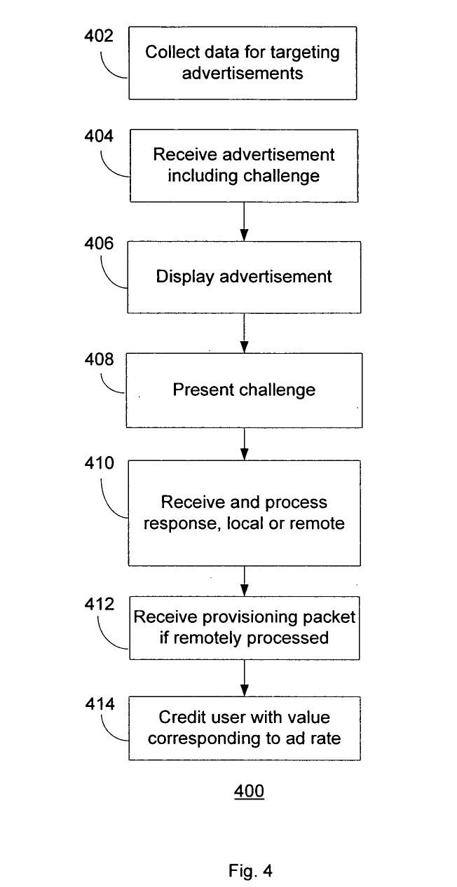

FIG. 4, a method 400 of attestation for paid consumption of advertising on a computer is discussed and described. At block 402, data may be collected for the purpose of targeting advertisements. The data may be used locally for selecting an advertisement from a database of advertisements, or the data may be sent to a server or ad targeting service for use in sending selected ads to the computer 110. More about data collection can be found in the priority document. At block 404, a targeted advertisement 300 may be received at the computer. The targeted advertisement 300 may include, as described above, a challenge. Depending on the application and the specific embodiment, the challenge may include a HIP indicia to make the challenge human discernable but not machine readable. It is anticipated that as technology advances, the nature of HIP indicia will similarly advance. In one embodiment, to limit the electronic distribution of answers to challenges, the challenge may be keyed to a particular computer using a hardware identifier or cryptographic keys stored in the computer's secure memory 126. The hardware identifier may be a unique ID, or may only be unique within a particular scheme, for example, by vendor. In one embodiment, the hardware identifier and an offer identifier, indicative of the contractual arrangement, may be used to create a scheme-wide unique identifier or even a globally unique identifier. For example, a correct answer may be concatenated with a hardware identifier and hashed when included in the advertisement. When the correct answer is provided on the computer 110, the hardware ID may be concatenated and the answer hashed using an agreed to algorithm. When the hashes match, the value associated with the advertisement may be credited.

The advertisement may be displayed at block 406. In one embodiment, a selection window may be displayed giving the user a selection of advertisements from which to pick. To improve effectiveness, a limit may be placed on the number of ads that are displayed in one session or in a particular period of time, such as per hour or per day. Alternatively, a limit may be placed on the number of challenges presented to the user. The limit on challenges may include the number of challenges presented per session or per time period, but may also include an aggregate value, e.g. more low value ads may be processed with challenges/responses than high value ads. When the computer 110 has met its limit, either quantity or value, for the given period, ads may be blocked, or, in another embodiment, ads may be displayed but no associated challenges presented. Additional responses, if presented, may also be ignored, for example, in the event that a user attempts to counterfeit a challenge, or capture and replay a previous challenge.

To improve the effectiveness of targeting, face recognition may be used in combination with the challenge/response. This may significantly increase the value of the ad delivery to the advertiser, since there can be a correlation of a particular ad targeting profile with the user consuming the advertisement. Displaying the advertisement may include displaying the challenge, either during the presentation of the advertisement or at the end. To promote the user actually watching the advertisement, the ad may be presented using the full screen with no other display elements over the ad presentation. The operating system may prevent other audio or display presentations during the presentation of the advertisement. Similarly, an audio channel associated with the advertisement may be controlled such that only the advertisement audio is presented while the ad is playing. In various embodiments, the ad may be visual only or audio only.

After the presentation of the challenge at block 408, input from the user may be received, including a response to the challenge at block 410. At block 411, the response may be analyzed for correctness. In one embodiment, the input may be directed to the cryptographic module 125 or other secure module for processing the response. The response may be encrypted (or decrypted) using keys associated with that particular paid advertisement or a group of paid advertisements. As mentioned above, the response may be hashed and compared to a hash of an expected response. In another embodiment, the challenge may ask the user to click on a particular spot on the screen, for example, by presenting a box at a particular screen coordinate. The screen coordinate may be generated by the cryptographic unit 125 or may be present in the video portion of the advertisement. As with the other challenges, the correct response, in this case, a range of screen coordinates corresponding to the box may be extracted from the advertisement by the cryptographic unit from data 316 associated with the advertisement. In another embodiment, the response data may be sent separately, for example, as a record or file associated with a database of advertisements used for locally targeted advertisements. The expected response data may be sent encrypted and then decrypted and stored in the secure memory 126.

To further narrow the response to an individual user, the response may be accompanied by a personal identifier, such as a personal identification number (PIN). Particularly in environments where a computer might be shared and usage credits are credited to an individual and not a computer, the user may be supplied with a token, such as a smartcard, for use in attestation. For example, a correct response may be signed by a personal private key that is unlocked using a password, following the “something you have plus something you know” protocol.

A secure channel may be created between the input device and the secure module to limit attacks on the response to the challenge. When processing is not done locally, a secure channel may be established with a remote server, such as server 30 or a web service and the response to the challenge sent over the secure channel. When the correct response is supplied, the “Yes” branch of block 411 may be followed to block 412. At block 412, the correct response may be recognized with a credit to the user's account. A provisioning packet, in one embodiment, attached to the advertisement or response, may be supplied to the computer's value management process. Alternatively, a request for a provisioning packet of the correct value may be made by the cryptographic module 125 to a provisioning server, such as server 30. When the response is processed remotely, a provisioning packet with the value corresponding to viewing the advertisement may be prepared and sent using the same process as purchased provisioning packets. Provisioning packet generation and processing is discussed in detail in co-pending U.S. patent application Ser. No. 10/989,122.

When an incorrect response is supplied, or fails for another reason, the “No” branch from block 411 may be followed to block 414, where the incorrect response may be analyzed with respect to a policy for incorrect responses. The policy may specify a number of allowable incorrect answers, either in total or during a period of time, for example, 3 incorrect answers per day or 30 incorrect answers per month. When the allowable number of incorrect answers has been exceeded, several response are possible, from noting a user's record but taking no action, to a follow up communication with the user, to disabling or even repossessing the computer 110. The policy may be directed to a single computer and thereby a single user or subscriber. Alternately, the policy may extend to a group of computers and correspondingly to a common owner, for example, a business or school. When the limit of incorrect responses is reached as an aggregate of group of computers, a sanction may be imposed or a higher level of monitoring may be initiated.

The user's actions following the verified advertising delivery may be monitored. For example, if the user navigates to the advertiser's web site, additional credit may be added to the value of the ad. Correlation to a purchase following the ad may increase further the value associated with the consumption of the ad. Whether received in a provisioning packet from a server or processed locally by the cryptographic module 125, after a correct response, particularly a cryptographically verified correct response, the value associated with consumption of the advertisement may be credited to an account maintained in the cryptographic module 125 or other, similar, secure module in the computer, such as a smart chip (not depicted). In another embodiment, account values may be stored remotely, in which case, the value associated with consumption of the ad may be credited to the remote account.

By following a process such as that described above, not only is the user given the opportunity to receive and view advertisements that may introduce targeted products and services of interest and the user can help obtain usage time or credits toward subscription prices for use of the pay-per-use or subscription computer. Using cryptographic measures to secure the challenge and response helps to prevent abuse of the payment-for-viewing process. By providing attested delivery of the targeted ad, the advertiser has high confidence in the effectiveness of the ad delivery channel. By watching the ad, the user is given compensation for their viewing time that directly benefits them in the use of his or her computer.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of attestation for paid consumption of advertising on a computer comprising:
receiving an advertisement and a challenge corresponding to the advertisement;
displaying the advertisement and the challenge;
receiving input from a user comprising a response to the challenge;
analyzing the response against a criteria; and
crediting the user with a value associated with the consumption of the advertisement when the response meets the criteria.

2. The method of claim 1, wherein the displaying the advertisement comprises presenting the advertisement unobstructed by other display elements over the full screen of the computer.

3. The method of claim 1, wherein the challenge is human discernable and not machine-readable.

4. The method of claim 1, wherein the challenge is a question corresponding to subject matter of the advertisement.

5. The method of claim 1, wherein the challenge is one of an audible segment, a watermark and a graphic including a stylized combination of characters.

6. The method of claim 1, further comprising processing the response to the challenge at the computer, wherein crediting the user with the value comprises processing the credit at a secure module in the computer.

7. The method of claim 1, further comprising processing the response to the challenge at the computer, wherein crediting the user with the value comprises sending a signal to a remote computer to initiate a value credit process.

8. The method of claim 1, further comprising processing the response to the challenge at a remote computer, wherein crediting the user with the value comprises sending a message comprising value credits from the remote computer to the computer.

9. The method of claim 1, wherein receiving input from the user comprises receiving input at a secure module for cryptographically verifying the response to the challenge against a cryptographically protected value corresponding to the advertisement.

10. The method of claim 9, wherein the cryptographically protected value is at least one of a hash of the correct response, an encrypted value associated with the correct response, and an encrypted screen coordinate corresponding to a screen location of the correct response.

11. The method of claim 9, wherein crediting the user with the value associated with the consumption of the advertisement comprises matching a face recognition value with a user associated with criteria for selection of the advertisement before crediting the user with the value.

12. The method of claim 9, wherein crediting the user with the value associated with the consumption of the advertisement comprises crediting the user with value when the cryptographically verifying the response to the challenge is successful.

13. The method of claim 1, further comprising sending the response to the challenge to a server for verification over a secure channel between the computer and the server, and receiving a provisioning packet from the server for crediting the user with value when the response to the challenge is verified.

14. The method of claim 1, further comprising linking computer-specific indicia in the advertisement to the computer.

15. The method of claim 1, further comprising determining an action according to a security policy when the response does not meet the criteria.

16. A computer arranged for use in viewing compensated advertisements comprising:
a memory storing an identifier unique within a scheme;
a port for receiving at least one advertisement;
a processor coupled to the memory and the port for executing instructions stored in a computer-readable medium; and
a computer-readable medium storing processor executable instructions for:
receiving a message including an advertisement;
presenting the advertisement;
receiving an input from a user, the input corresponding to human-discernable information presented corresponding to the advertisement;
analyzing the input against a predetermined criterion; and
adding value to a user account when the input matches the predetermined criterion.

17. The computer of claim 16, wherein the computer-readable medium further stores processor executable instructions for determining that an indicia in the advertisement matches the identifier.

18. The computer of claim 16, wherein the computer-readable medium further stores processor executable instructions for limiting the adding value to a user account according to a policy governing an maximum added value in a time period.

19. A computer-readable medium having computer executable instructions for implementing a method of determining consumption of a targeted advertisement by a human comprising:
collecting data corresponding to user preferences;
receiving the targeted advertisement including an indicia and a criterion for proving consumption of the targeted advertisement;
displaying the targeted advertisement including the indicia;
receiving an input from a user based on the indicia;
determining when the input matches the criterion; and
adding value to a user account when the input matches the criterion.

20. The computer-readable medium having computer executable instructions of claim 19, further comprising:
transferring a cryptographic secret to the computer for use in determining when the input matches the criterion,
performing a cryptographic operation using the secret on at least one of the input and the criterion when determining when the input matches the criterion.
